(19) United States
(12) Patent Application Publication
(10) Pub. No.: US 2017/0250590 A1
(43) Pub. Date: Aug. 31, 2017

(54) System for Method for Generating Hydro Electricity

(71) Applicant: Rafael Cruz Reyes, New York, NY (US)

(72) Inventor: Rafael Cruz Reyes, New York, NY (US)

(21) Appl. No.: 15/202,852

(22) Filed: Jul. 6, 2016

Related U.S. Application Data
(60) Provisional application No. 62/179,533, filed on May 11, 2015.

(51) Int. Cl. H02K 7/18; F03B 13/10; F01D 15/10

(52) U.S. Cl. CPC H02K 7/1823; F01D 15/10; F03B 13/10; F03B 17/005

(57) ABSTRACT

A method for providing a hydro-electric system is disclosed. The hydro-electric system includes: a housing assembly, wherein the housing assembly includes a wheel assembly of energy; the supply assembly includes a wheel and a wheel cover charge, which protects the wheel cover an outer part of the wheel assembly and the supply assembly in rotation.

### FIELD OF THE INVENTION

The present invention relates to a system and method for generating hydroelectric power.

### BACKGROUND OF THE INVENTION

A conventional hydroelectric system generally includes one or more rotating water turbines, which usually are arranged in rivers, lakes or reservoirs. Using the potential differences flow of water to conduct water to turn turbines, water turbines can also drive one or more power generators in the hydroelectric system to generate electricity.

However, conventional hydropower system is, not a closed system when the water flow is used to drive turbines water, so that external objects such as debris, stones and sand can be easily placed on the hydroelectric system to lock and damage the blades of the water turbine adversely affect the efficiency of power generation. In addition, they may require additional maintenance costs to repair damaged turbine blades water.

Furthermore, water turbines in hydroelectric current systems are generally arranged vertically. Namely, water turbines are arranged linearly from a higher to a lower place, so that the height between the highest and lowest points is fixed. Furthermore, each water turbine occupies certain spaces, so that the number of water turbines is limited and the power generation efficiency. Therefore, there remains a need for a new and improved hydroelectric system to overcome the aforementioned problems.

### SUMMARY OF THE INVENTION

The present invention has been made in view of the aforementioned technical background, and it is an object of the present invention to provide a method and a system for hydroelectric power generation.

A method for providing a hydro-electric system is disclosed. A housing assembly, wherein the housing assembly includes a set of energy wheels; the power cover assembly includes a wheel and a wheel load, wheel cover protects an outer part of the wheel assembly; and supply assembly is configured to receive water that moves the whole source in a clockwise rotation in the joint movement of the source transfers energy to the load wheel, wherein the wheel load converts movement into electrical energy.

### BRIEF DESCRIPTION OF THE DRAWINGS

These and other advantages of the present invention will become more apparent as the following description read in conjunction with the accompanying drawings, wherein:

FIG. 1 is a flowchart of how the present invention works

FIG. 2 shows a set of side plates in accordance with the invention;

FIG. 3 shows an illustration of a power wheel assembly according to the invention;

FIG. 4A-4D shows the supply assembly attached to the side plate assembly according to the invention; and

FIG. 5 shows how the whole feed wheel with the set of side plates according to the invention works; and

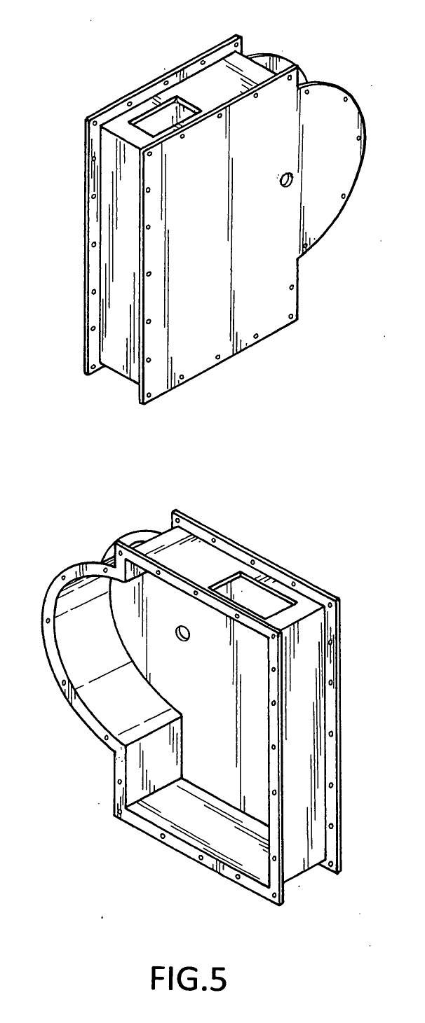

FIG. 6 shows a set of main housing according to the invention.

### DETAILED DESCRIPTION OF THE INVENTION

The presently preferred embodiments of the invention are described with reference to the drawings, where like components are identified with the same numbers. The descriptions of preferred embodiments are exemplary and are not intended to limit the scope of the invention.

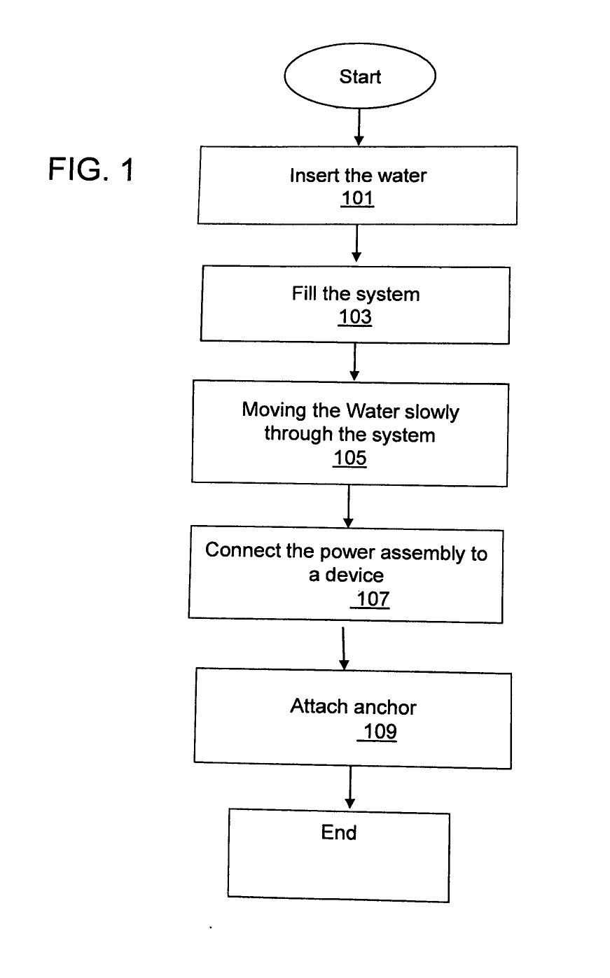

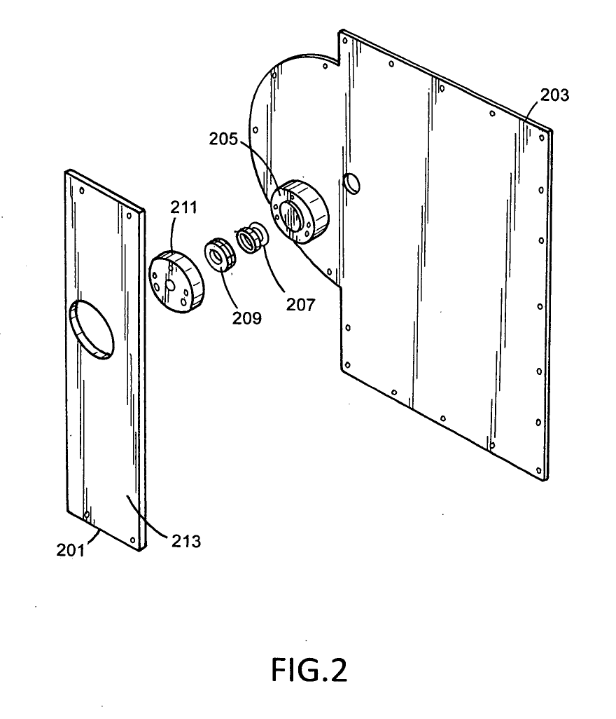

FIG. 1 is a flowchart of how the invention works. In block 101, any liquid is poured into the hydroelectric system. Hydroelectric System includes a set of side plate 201 having a side plate 203, shaft housing seal 205, the mechanical seal 207, which leads 209, bearing housing 211 or rotor and plate Optional reinforcement 213. (FIG. 2) shaft seal housing 205 is connected to the mechanical shaft seal 207 which is connected to the bearing 209, which is in the bearing housing 211.

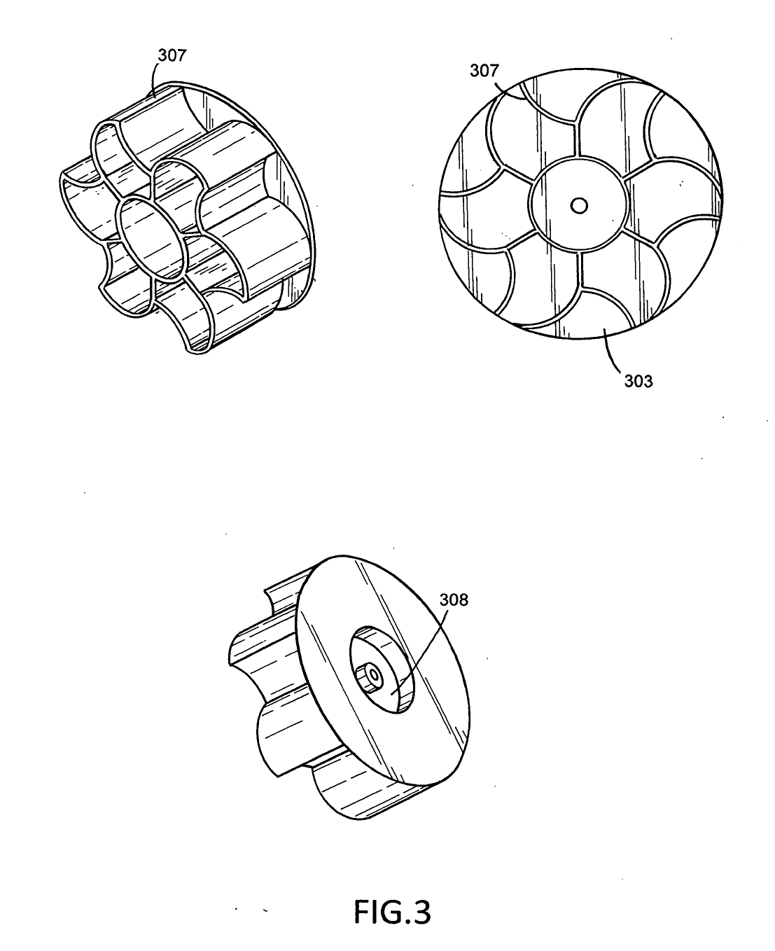

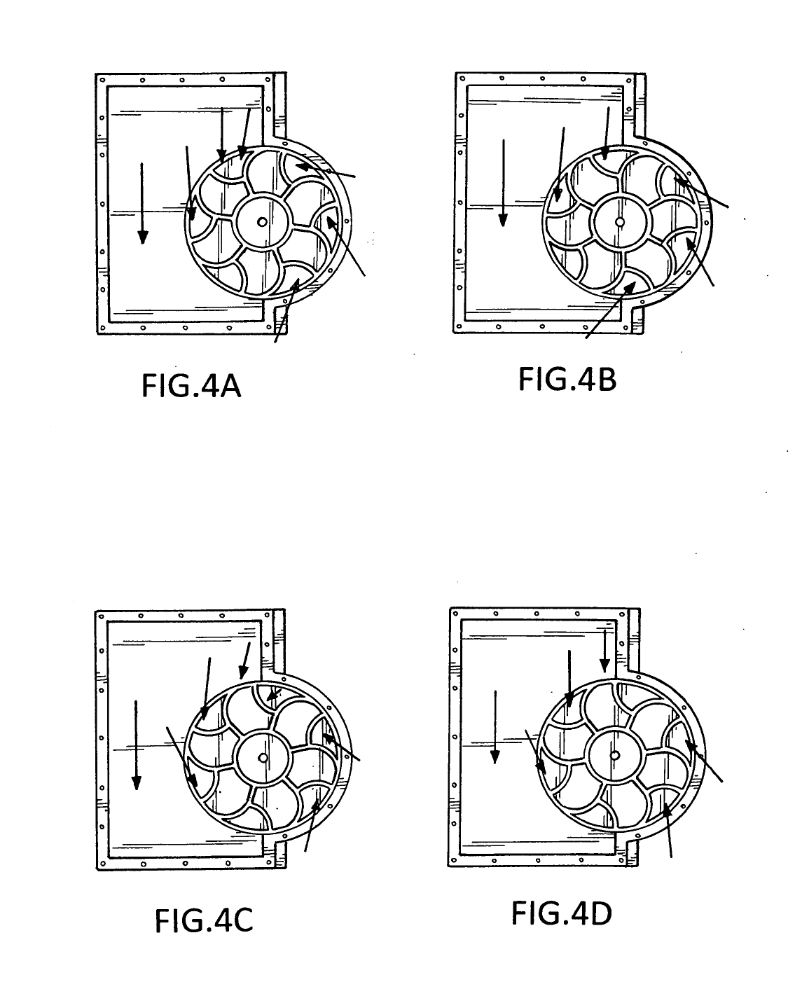

In block 103, the bearing housing 211 does not move as it fills. The heart of the bearing housing 211 pushes the moving water until a set of feed wheel 301 (FIG. 3). Wheel assembly 301 includes a power wheel cover 303, a wheel load structural components 305 and 307 rotational turning structural components 307 are used to move any kind of liquid such as water through the supply assembly 301. Returning to block 105, the water moves slowly through the bearing housing 211 by the weight of water, but the bearing housing 211 or rotor speed begins to take based on the Archimedes principle then by the bearing housing 211 fast moving electricity can be exploited as shown in FIGS. 4A-4D. The weight of the water moves the supply assembly 301 as shown in FIGS. 4A-4D in a counter-clockwise motion based on the Archimedes principle that is used to generate electricity.

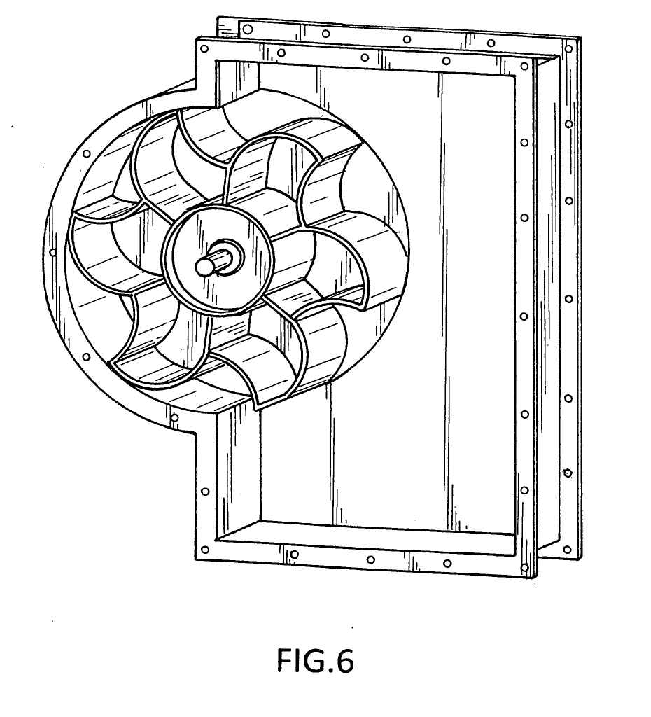

In block 107, the supply assembly 301 is connected to another device such as a generator, compressor or water pump. The source assembly 301 generates electricity is transferred to the generator. In block 109, in order to obtain this invention ground anchor is attached to it so that it does not move when electricity is being generated. FIG. 6 shows the combination of the supply assembly 301 and side plates of FIG. 2 working in conjunction to generate the hydro-electricity.

FIG. 3 shows a main assembly including a wheel assembly of the inner energy of the set of side plates. The supply assembly 301 is in a side portion of the set of side plates 101 where the shaft 103 and bearing 105 maintains the supply assembly 301 in place.

This invention provides a method for providing a hydro-electric system. A housing assembly, wherein the housing assembly includes a set of energy wheels; the power cover assembly includes a wheel and a wheel load, wheel cover protects an outer part of the wheel assembly; and supply assembly is configured to receive water that moves the whole source in a clockwise rotation in the joint movement of the source transfers energy to the load wheel, wherein the wheel load converts movement into electrical energy.

Although the present invention has been described above in terms of specific embodiments, many modifications and variations of this invention can be made as will be apparent to those skilled in the art without departing from its spirit and scope as set forth in the following claims.

What is claimed is:

1. A method for providing a hydroelectric system;
a housing assembly, wherein the housing assembly includes a wheel assembly of energy;
the supply assembly includes a cover wheel and a load wheel, wherein the wheel cover protects an outer part of the wheel assembly; and
the supply assembly is configured to receive the water supply assembly is moved in a clockwise rotation in which the whole moving;source transfers energy to the load wheel, wherein the wheel load converts movement into electrical energy.

2. The method of claim 1, wherein the power wheel has multiple configurations to move the water to generate electricity.

3. The method of claim 1, providing a connector loading wheel to a generator generating electricity based on rotation of font set.
